(19) United States
(12) Patent Application Publication
(10) Pub. No.: US 2013/0152795 A1
(43) Pub. Date: Jun. 20, 2013

(54) ADSORPTION VESSELS HAVING REDUCED VOID VOLUME AND UNIFORM FLOW DISTRIBUTION

(71) Applicants: Kirit M. Patel, Winfield, IL (US); Bradley P. Russell, Wheaton, IL (US); Paul Alvin Sechrist, South Barrington, IL (US); Michael Jerome Vetter, Schaumburg, IL (US); Hua Chen, Pleasant Prairie, WI (US); Pengfei Chen, Des Plaines, IL (US)

(72) Inventors: Kirit M. Patel, Winfield, IL (US); Bradley P. Russell, Wheaton, IL (US); Paul Alvin Sechrist, South Barrington, IL (US); Michael Jerome Vetter, Schaumburg, IL (US); Hua Chen, Pleasant Prairie, WI (US); Pengfei Chen, Des Plaines, IL (US)

(73) Assignee: UOP LLC, Des Plaines, IL (US)

(21) Appl. No.: 13/330,448

(22) Filed: Dec. 19, 2011

(51) Int. Cl. B01D 53/02

(52) U.S. Cl. 96/152

(57) ABSTRACT

Adsorption vessels and systems utilizing adsorption vessels are provided herein. In one embodiment, an adsorption vessel for receiving a fluid mixture and for separating a component from therein includes a vessel wall extending from a bottom end to a top end and defining a vessel chamber. A bottom inlet is formed in the bottom end of the adsorption vessel for introducing the fluid mixture to the vessel chamber. Further, a support plate is positioned in the vessel chamber above the bottom end, and defines a bottom void volume between the support plate and the bottom end. A filler material having a total porosity of less than about 25% is positioned in the bottom void volume and defines a channel for flow of the fluid mixture from the bottom inlet to the support plate.

### TECHNICAL FIELD

The present invention relates generally to pressure swing adsorption (PSA) systems and vessels, and more particularly relates to PSA vessels having reduced void volume and uniform flow distribution during processing.

### BACKGROUND

Pressure swing adsorption processes can separate selectively adsorbable components, such as carbon monoxide, carbon dioxide, methane, ammonia, hydrogen sulfide, argon, nitrogen, and water, from gas mixtures. Often, one or more of these components are adsorbed to purify a fluid stream, such as hydrogen gas. Typically, a PSA process uses an adsorber that includes a vessel surrounding an adsorbent bed formed with adsorbent particles. Generally, void volumes in the adsorber vessel include volumes within porous adsorbent particles, volumes between particles, and internal volumes defined by the walls of the vessel and the adsorbent bed.

These void volumes can decrease the efficiency of the PSA process. Specifically, the void volumes may lead to loss of recovered product such as hydrogen. Although adsorbent can be placed in the void volume to reduce the void volume, such a solution is undesirable as it adversely affects the gas flow distribution and pressure drop through the adsorbent bed. For enhanced processing performance, distribution of gases in the vessel is uniform. However, placing adsorbent in the void volume can create non-uniformity that is generally undesirable. Generally, it would be desirable to minimize the void volume in the vessel without increasing pressure drop and flow non-uniformity through the adsorbent.

Accordingly, it is desirable to provide adsorption vessels that have reduced void volumes. Also, it is desirable to provide adsorption vessels that exhibit reduced pressure drop during separation processing. Furthermore, other desirable features and characteristics will become apparent from the subsequent detailed description and the appended claims, taken in conjunction with the accompanying drawings and the foregoing technical field and background.

### BRIEF SUMMARY

Adsorption vessels having reduced void volume and uniform flow distribution are provided herein. In an exemplary embodiment, an adsorption vessel is provided for receiving a fluid mixture and for separating a component from therein. The adsorption vessel includes a vessel wall extending from a bottom end to a top end. The vessel wall defines a vessel chamber. A bottom inlet is formed in the bottom end of the vessel for introducing the fluid mixture to the vessel chamber. A support plate is positioned in the vessel chamber above the bottom end, and defines a bottom void volume between the support plate and the bottom end. Further, a filler material having a total porosity of less than about 25% is positioned in the bottom void volume and defines a channel for flow of the fluid mixture from the bottom inlet to the support plate.

In accordance with another exemplary embodiment, an adsorption vessel is formed with a vessel chamber for receiving a fluid mixture and for separating a component therein. The vessel includes a perforated support plate positioned in the vessel chamber and defining an adsorbing zone above the perforated support plate and an inlet zone below the perforated support plate. A bottom inlet is formed in the vessel for introducing the fluid mixture to the inlet zone. Further, a filler material having a total porosity of less than about 25% is positioned in the inlet zone and defines a channel for flow of the fluid mixture from the bottom inlet to the perforated support plate. The filler material fills over 50% of the inlet zone.

In accordance with another exemplary embodiment, an adsorption system is provided for separating a component from a fluid mixture. The system includes at least one vessel having a vessel wall that extends from a bottom end to a top end and that defines a vessel chamber. A bottom inlet is formed in the bottom end of the vessel for introducing the fluid mixture to the vessel chamber. The bottom inlet defines an axis. The adsorption vessel includes a support plate positioned in the vessel chamber above the bottom end. The support plate defines a bottom void volume between the support plate and the bottom end. Further, a bed of adsorbent material is positioned in the vessel chamber above the support plate to selectively adsorb the component of the fluid mixture. Also, an inner support ring is mounted to the bottom end surrounding the axis, and an outer support ring is mounted to the bottom end surrounding the inner support ring. The vessel includes a filler material having a total porosity of less than about 25% positioned in the bottom void volume between the inner support ring and the outer support ring. The filler material defines a channel for flow of the fluid mixture from the bottom inlet to the support plate.

### BRIEF DESCRIPTION OF THE DRAWING

The adsorption vessels will hereinafter be described in conjunction with the following drawing figures, wherein like numerals denote like elements, and wherein:

FIG. 1 is a schematic view of a processing system including an adsorption vessel in accordance with an exemplary embodiment; and

FIG. 2 is a side cross-sectional view of the adsorption vessel of FIG. 1 in accordance with an exemplary embodiment.

### DETAILED DESCRIPTION

The following Detailed Description is merely exemplary in nature and is not intended to limit the adsorbent system or adsorbent vessel or the application and uses of the adsorbent system or adsorbent vessel. Furthermore, there is no intention to be bound by any theory presented in the preceding background or the following detailed description.

The various embodiments contemplated herein relate to adsorption vessels and systems that have reduced void volume, exhibit reduced pressure drop, and provide uniform flow distribution. Further, the adsorption vessels and systems are able to reduce cycle time by about 30% to about 50%. The adsorption vessels herein utilize filler material to reduce void volume, leading to improved process performance in PSA processes. The filler material has a total porosity of less than about 25%, such as less than about 20%, less than about 15%, or less than or about 10%. As used herein, “total porosity” is a measure of the void volume, including intramaterial void volume within material particles and intermaterial void volume between material particles, as a percentage of the total volume of the filler material. The total volume, or bulk volume, of the filler material includes the solid and void components.

PSA technology is based upon the capacity of adsorbents to selectively adsorb and desorb particular gases as gas pressure is raised and lowered. Due to selective adsorption, impurities may be removed from a desired product gas. In many commercial uses of PSA systems, off gas from refineries or chemical plants is fed into a PSA system for separation. In an exemplary use, the feed is the off gas from a steam methane reformer and includes about 75 mol. % hydrogen, about 15 mol. % carbon dioxide, about 3 to 4 mol. % carbon monoxide, about 5 mol. % methane, and about 0.5 mol. % nitrogen. The PSA system is able to separate a product stream of 99.9 mol. % hydrogen from such a feed.

The PSA process involves a cyclic repetition of four basic steps: production, depressurizing, purging, and repressurizing. First, the feed gas mixture is fed under high pressure into vessels containing adsorbent material, typically alumina, silica gel, activated carbon, molecular sieves, or the like. Impurities in the feed gas adsorb onto the internal surfaces of the porous adsorbent, leaving purified product gas in the void spaces of the vessel. Product gas is then withdrawn from the top of the vessel under pressure. The pressure in the adsorption vessels is then reduced, and product gas remaining in the void spaces of the vessel is removed. The adsorbed impurities are released back into the gas phase, regenerating the adsorbent bed. The vessel is then purged with a small amount of purified product gas, to complete regeneration of the adsorbent bed. Impurities exit the PSA process in a low-pressure exhaust stream. Finally, the vessel is repressurized with a mixture of product gas from the depressurization step, feed gas, and high-purity product gas. This cycle is repeated about every 5 to 10 minutes in conventional PSA systems.

Because each cycle is essentially a batch process, multiple pressure vessels are typically used together in sequence to provide a semicontinuous flow of product gas. In addition, large surge tanks are used to dampen variations in flows of feed, product and exhaust streams. To fully utilize the adsorbent material employed, PSA systems require uniform flow of gas across the adsorbent vessel(s) throughout the PSA processing cycle. In addition, void volume and pressure drops in the PSA vessel entrance and exit regions (i.e., the inlets and outlets and their associated headers) have adverse effects on the process performance of a PSA system and must be minimized in practical commercial operations.

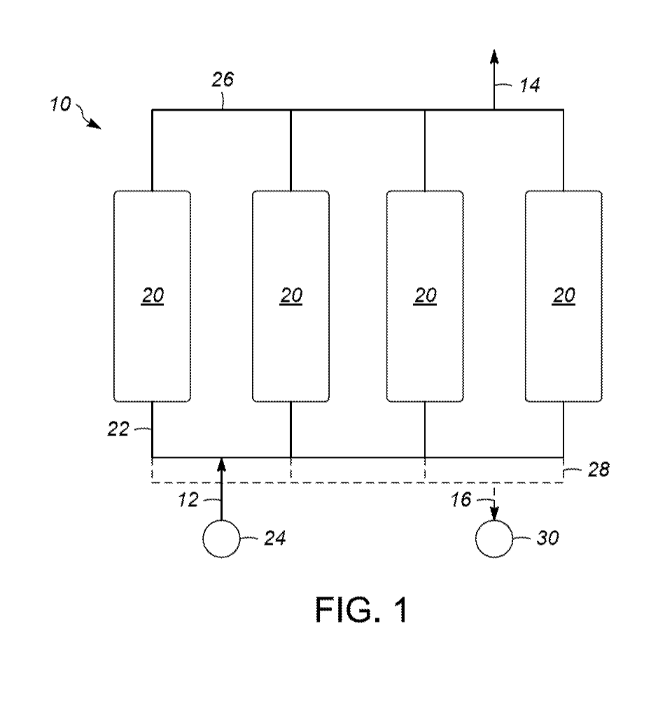

In accordance with an exemplary embodiment contemplated herein, an apparatus 10 for performing selective adsorption is illustrated in FIG. 1. As shown, the system receives a feed stream 12 and separates it into a product stream 14 and an impurities stream 16. The apparatus 10 is provided with adsorption vessels 20 where impurities are removed from the feed stream 12. While four vessels 20 are shown in FIG. 1, typically ten vessels are provided in an apparatus 10 and an apparatus 10 may include up to sixteen vessels, or more. Often the vessels 20 operate in parallel, though they may be connected in series for additional processing benefits, such as repressurizing.

As shown, the feed stream 12 is delivered to the vessels 20 through feed lines 22. Further, the feed lines 22 are connected to a pressure source 24 for pressurization to an upper adsorbent pressure. During the high pressure product producing step in the PSA cycle, the product stream 14 exits the vessels 20 through outlet lines 26. Further, the apparatus 10 includes impurities lines 28 for removal of the impurities during regeneration steps in the PSA cycle. As shown, the impurities lines 28 may be connected to a low pressure sink 30 for removal of the impurities from the vessels 20.

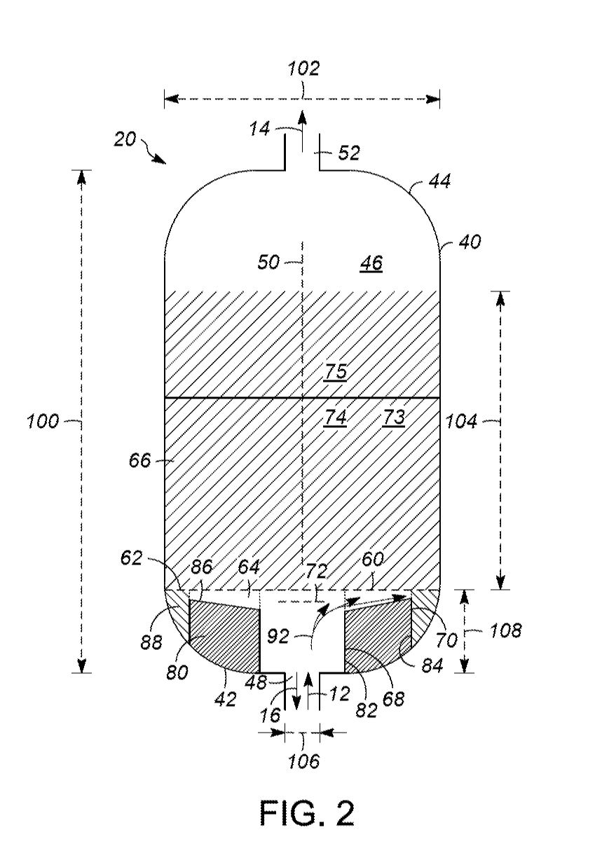

Referring now to FIG. 2, the structure of an exemplary adsorbent vessel 20 is illustrated. The exemplary adsorbent vessel 20 includes a substantially cylindrical vessel wall 40 that extends from a bottom end 42 to a top end 44 and encloses a vessel chamber 46. As shown, an inlet 48 is formed in the bottom end 42 for receiving the feed stream 12 and for evacuating the impurities stream 16. The inlet 48 and vessel wall 40 define an axis 50. Further, a product outlet 52 is formed in the top end 44 for releasing the product stream 14.

The vessel 20 is provided with a perforated support plate 60. The support plate 60 defines a plane 62 and can be considered to divide the vessel chamber 46 into an inlet zone 64 and an adsorbing zone 66. As shown, the support plate 60 sits on, and is connected to, such as by a bolted connection, an inner support ring 68 and an outer support ring 70. Each of the support rings 68, 70 is cylindrical and is perforated near its respective top. As shown, the inner support ring 68 is centered about the axis 50 and the outer support ring 70 is centered about the inner support ring 68. The vessel 20 may also include a perforated deflector 72 for deflecting gas flow.

In FIG. 2, adsorbent material 73 is positioned in the vessel chamber 46 above the support plate 60. As indicated above, the adsorbent material 73 is chosen to selectively adsorb impurities from the desired product gas, and may be, for example, alumina, silica gel, activated carbon or molecular sieves. In addition, these adsorbents may form multiple layers. For example, in FIG. 2 a first adsorbent layer 74 of activated carbon is positioned on top of the support plate and occupies about 60% of the total adsorbent volume. A second adsorbent layer 75 of zeolite molecular sieve is positioned on top of the activated carbon layer and occupies the remaining 40% of the adsorbent volume.

In order to reduce void volume in the vessel 20, a filler material 80 is positioned in the inlet zone 64 below the support plate 60. The filler material 80 may be, for example, polymeric closed cell foams, liquid, concrete, refractory insulation, plastic blocks, granite blocks, ceramic balls, sand, paraffin wax, or combinations thereof. As stated above, the total porosity of the filler material, whether a single material or combination of materials, is less than about 25%, such as less than 20%, less than 15%, or less than 10%. As shown, the filler material 80 forms an annular or ring shape, and abuts an outer face 82 of the inner support ring 68. Further, the filler material 80 abuts an inner face 84 of the outer support ring 70. The filler material 80 extends along the bottom end 42 of the vessel 20 between the inner support ring 68 and outer support ring 70. The vessel 20 may also include a cover 86 for the filler material 80. The cover 86 may be a membrane bag, or a structural element such as sheet metal, for holding the filler material 80 in place, particularly during shipping. As shown, in the volume between the outer support ring 70 and the vessel wall 40, a plurality of ceramic balls 88 may be positioned to further reduce void volume, to prevent seepage of adsorbent material 74 below the support plate 60 along the vessel wall 40, and to aid in flow distribution.

The filler material 80 is utilized to reduce void volume in the vessel 20 and to define channels or flow paths for the feed mixture (arrows 92). The flow paths pass through the perforated upper portions of the support rings 68. 70. As shown, the flow paths are bounded by the filler material 80 and/or cover 86, and by the vessel wall 40 below the perforated support plate 60. As shown, vessel 20 has a vessel height 100, a chamber inner diameter 102, an adsorbent bed height 104, an inlet inner diameter 106, and a support plate height 108.

In another exemplary embodiment, vessel 20 has a volume of about 15.857 cubic meters (or about 560 cubic feet) and a total inlet zone volume of between about 3% and about 15% of the vessel volume, for example about 6% or about 8.5% of the vessel volume. Within the inlet zone 64, the filler material fills about 50% of the inlet zone volume. As a result, the remaining void volume in the inlet zone is about 4% of the vessel volume, and the filler material volume is between about 2% and about 10% of the vessel volume, such as about 3% or about 4.5% of the vessel volume.

As a result of the placement, design and volume of the filler material 80, as well as the material properties including low total porosity, the void volume of the vessel 20 is reduced without disrupting uniform flow distribution of the feed gas mixture and without increasing pressure drop across the vessel. As a result, process efficiency is increased. For example, the decreased amount of void volume results in decreased product gas (for example, hydrogen) lost to the impurities stream 16 during depressurization of the vessel in the PSA processing cycle. As a result, the cycle time itself can be reduced, resulting in a shorter necessary bed height 104 without decreasing the fractional recovery of product stream 14 from feed gas stream.

Accordingly, adsorbent systems and vessels for separating impurities from a product gas have been described. The adsorbent vessels are provided with filler material for reducing void volume to improve processing efficiency. While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of filing this patent application.

What is claimed is:

1. An adsorption vessel for receiving a fluid mixture and for separating a component from therein, the adsorption vessel comprising:
a vessel wall extending from a bottom end to a top end and defining a vessel chamber;
a bottom inlet formed in the bottom end of the vessel for introducing the fluid mixture to the vessel chamber;
a support plate positioned in the vessel chamber above the bottom end and defining a bottom void volume between the support plate and the bottom end; and
a filler material having a total porosity of less than about 25% positioned in the bottom void volume and defining a channel for flow of the fluid mixture from the bottom inlet to the support plate.

2. The adsorption vessel of claim 1 further comprising adsorbent material positioned in the vessel chamber above the support plate, wherein the adsorbent material selectively adsorbs the component from the fluid mixture.

3. The adsorption vessel of claim 1 wherein the vessel chamber defines a vessel volume, wherein the bottom void volume comprises about 3% to about 15% of the vessel volume, and wherein the filler material defines a filled volume of about 2% to about 10% of the vessel volume.

4. The adsorption vessel of claim 3 wherein the filled volume occupies about 50% of the bottom void volume and wherein the bottom void volume occupies about 6% of the vessel volume.

5. The adsorption vessel of claim 4 wherein the filled volume occupies about 3% of the vessel volume.

6. The adsorption vessel of claim 1 wherein the filler material has a total porosity of less than about 10%

7. The adsorption vessel of claim 1 wherein the bottom inlet defines an axis, the vessel further comprising an inner support ring positioned in the bottom end and surrounding the axis, wherein the inner support ring has a outer face, and wherein the filler material abuts the outer face of the inner support ring.

8. The adsorption vessel of claim 7 further comprising an outer support ring positioned in the bottom end and surrounding the inner support ring.

9. The adsorption vessel of claim 8 wherein the outer support ring has an inner face, and wherein the filler material abuts the inner face of the outer support ring.

10. The adsorption vessel of claim 8 wherein the inner support ring and the outer support ring include perforated upper portions, and wherein the channel passes through the perforated upper portions.

11. The adsorption vessel of claim 10 wherein the upper portions of the inner support ring and the outer support ring are connected to the support plate.

12. The adsorption vessel of claim 1 wherein an annular portion of the vessel wall bounds the channel between the support plate and the filler material.

13. The adsorption vessel of claim 1 wherein the filler material is chosen from the group comprising polymeric closed cell foams, liquid, concrete, refractory insulation, plastic blocks, granite blocks, ceramic balls, sand, paraffin wax, and mixtures thereof.

14. The adsorption vessel of claim 13 wherein the liquid is contained within a membrane bag.

15. An adsorption vessel formed with a vessel chamber for receiving a fluid mixture and for separating a component therein, the adsorption vessel comprising:
a perforated support plate positioned in the vessel chamber and defining an adsorbing zone above the perforated support plate and an inlet zone below the perforated support plate;
a bottom inlet formed in the adsorption vessel for introducing the fluid mixture to the inlet zone; and
a filler material having a total porosity of less than about 25% positioned in the inlet zone and defining a channel for flow of the fluid mixture from the bottom inlet to the perforated support plate, wherein the filler material fills over 50% of the inlet zone.

16. The adsorption vessel of claim 15 wherein the filler material has a total porosity of less than about 10%.

17. The adsorption vessel of claim 15 wherein the adsorption vessel includes a vessel wall, and wherein an annular portion of the adsorption vessel wall bounds the channel between the perforated support plate and the filler material.

18. The adsorption vessel of claim 15 wherein the filler material is chosen from the group comprising polymeric closed cell foams, liquid, concrete, refractory insulation, plastic blocks, granite blocks, ceramic balls, sand, paraffin wax, and combinations thereof.

19. The adsorption vessel of claim 15 wherein the vessel chamber defines a vessel volume, wherein the inlet zone forms about 6% of the vessel volume, and wherein the filler material defines a filled volume of about 3% of the vessel volume.

20. An adsorption system for separating a component from a fluid mixture, the system comprising at least one vessel comprising:
a vessel wall extending from a bottom end to a top end and defining a vessel chamber;
a bottom inlet formed in the bottom end of the vessel for introducing the fluid mixture to the vessel chamber, wherein the bottom inlet defines an axis;
an inner support ring positioned in the bottom end and surrounding the axis;
an outer support ring positioned in the bottom end and surrounding the inner support ring; and
a support plate positioned on the inner support ring and on the outer support ring, and defining a bottom void volume between the support plate and the bottom end;
a bed of adsorbent material positioned in the vessel chamber above the support plate, wherein the bed of adsorbent material selectively adsorbs the component of the fluid mixture;
a filler material having a total porosity of less than about 25% positioned in the bottom void volume between the inner support ring and the outer support ring and defining a channel for flow of the fluid mixture from the bottom inlet to the support plate.
